(19) United States
(12) Patent Application Publication
(10) Pub. No.: US 2017/0364685 A1
(43) Pub. Date: Dec. 21, 2017

(54) PROVIDING SECURITY TO COMPUTING SYSTEMS

(71) Applicant: INTERDIGITAL PATENT HOLDINGS. INC., Wilmington, DE (US)

(72) Inventors: Yogendra C. SHAH, Exton, PA (US); Andreas SCHMIDT, Frankfurt am Main (DE); John W. MARLAND, Dripping Springs, TX (US)

(21) Appl. No.: 15/528,257

(22) PCT Filed: Nov. 20, 2015
(86) PCT No.: PCT/US2015/061928

§ 371 Date: May 19, 2017

Related U.S. Application Data
(60) Provisional application No. 62/082,347, filed on Nov. 20, 2014.

(51) Int. Cl. G06F 21/57; G06F 21/53; G06F 9/455

(52) U.S. Cl. CPC G06F 21/575; G06F 21/53; G06F 2009/45562; G06F 9/45554; G06F 9/45558; G06F 2009/45587

(57) ABSTRACT

Described herein are methods, device, and systems that provide security to various computing systems, such as, smartphones, tablets, personal computers, computing servers, or the like. Security is provided to computing systems at various stages of their operational cycles. For example, a secure boot of a base computing platform (BCP) may be performed, and security processor (SecP) may be instantiated on the BCP. Using the SecP, an integrity of the OS of the BCP may be verified, and an integrity of a hypervisor may be verified. A virtual machine (VM) may be created on the BCP. The VM is provided with virtual access to the SecP on the BCP. Using the virtual access to the TAM, an integrity of the guest OS of the VM is verified and an integrity of applications running on the guest OS are verified.

### CROSS REFERENCE TO RELATED APPLICATIONS

This Application claims the benefit of U.S. Provisional Patent Application Ser. No. 62/082,347, filed Nov. 20, 2014, the disclosure of which is hereby incorporated by reference as if set forth in its entirety.

### BACKGROUND

The next wave of Internet evolution will have a profound impact on society as a whole, much like the Internet had after it first arrived. Communications networks and computing systems are transforming the way people interact with each other. For example, the core infrastructure that controls communications systems may be implemented with cloud-based functionality. Similarly, current Internet infrastructure and computing is becoming more distributed in nature. For example, data often resides on devices and the cloud, and data is processed on devices and the cloud. These changes are introducing new security vulnerabilities that may impact the core of the security of various platforms that store and process data. Intelligent device networking, which can be referred to generally as the Internet of Things, also presents security challenges. As more “things,” such as people, sensors, light bulbs, consumer goods, machinery, and personal appliances for example, are connected to the Internet, security vulnerabilities increase. For example, there may be more opportunities for fraudulent activities, and the sophistication of fraudulent activities may increase. Using the Internet of Things, for example, additional services can be enabled and enhanced. Existing approaches to offering such services lack security.

In view of the breadth of wireless devices available on the market and the continued broadening of the range of products that are available, from consumer products to machine-to-machine (M2M) devices with embedded wireless connectivity, for example, a scalable platform security solution that addresses security of communications and devices (e.g., M2M devices, cloud servers, etc.) is desirable. Furthermore, modern cloud computing services are based on virtual computers (machines) running on a single physical computer. Code and data on the virtual machines are typically owned by different stakeholders, which can be referred to as cloud consumers. Cloud consumers are generally concerned about the security of their data in the cloud (at rest) and during processing. Data at rest is typically protected by encryption, which is often supported by hardware-based security, such as a trusted processing module (TPM) chip for example, to protect encryption keys.

### SUMMARY

Described herein are methods, device, and systems that provide security to various computing systems, such as, presented by way of example and without limitation, smartphones, tablets, personal computers, computing servers, or the like. Security is provided to computing systems at various stages of their operational cycles. Example stages include start-up, the stage in which a computing system is started and an operating system is securely activated, the stage in which a run-time environment for applications is securely established, and the stage in which essential application programs and libraries are securely loaded and protected during a run-time operation. A secure boot process may be the foundation of an integrity validation procedure. A chain of trust may be initiated by an immutable hardware root of trust (RoT) that verifies the validity of the initial code loaded, and the boot process continues as each stage verifies a subsequent stage through a chain of trust. In an example embodiment, a secure boot of a base computing platform (BCP) is performed, and a security processor (SecP) and a Trust Access Monitor (TAM) are instantiated on the BCP. Using the SecP and TAM, an integrity of the OS of the BCP may be verified, and an integrity of a hypervisor may be verified. A virtual machine (VM) may be created on the BCP. The VM is provided with virtual access to the SecP and TAM on the BCP. Using the virtual access to the SecP and TAM, an integrity of the guest OS of the VM is verified and an integrity of applications running on the guest OS are verified.

In one example embodiment, a computing system comprises a SecP and trust access monitor and at least one memory. The SecP includes functionality typically found in a Trusted Processing Module (TPM), such as secure storage for example. The SecP may further provide functionality associated with Platform Configuration Registers (PCRs), key management, attestation keys, cryptographic functions, etc. The computing system verifies a first trusted reference value associated with a first component at a first stage so as to validate integrity of the first component. The computing system further verifies a second trusted reference value associated with a second component at a second stage so as to validate an integrity of the second component so as to form a portion of a chain of trust. For example, the second stage can be associated with a run-time operation, and the first stage can be associated with a boot-up process of the computing system. The run-time operation includes an application executing on the computing system. In accordance with another embodiment, the at least one memory of the computing system can be secured using the chain of trust. Further, segments, such as a segment of the second component for example, can be dynamically reloaded. Segments may also be referred to as subcomponents, and both refer to portions of a component comprising data and code. Such reloading may occur during run-time, for example, when lesser-used code and data are unloaded to create space for new code and data (e.g., page swapping and caching). Before reloading, segments, such as the segment of the second component for example, may be revalidated to securely bind a load-time validation with a run-time validation. Such binding may be accomplished via secure memory access control mechanisms described herein. In accordance with another example, the computing system generates a plurality of segment trusted reference values that can be used to validate a plurality of segments of respective components. The plurality of segment trusted reference values may be validated by the computing system. The generation of a plurality of segment trusted reference values may be bound against respective trusted reference values associated with the respective components.

In another example embodiment, a secure boot of a base computing platform (BCP) is performed, and a security processor is verified and instantiated on the BCP. An integrity of one or more subsequent startup components of the BCP is verified, using the security processor. The one or more subsequent startup components may include at least one of boot code, an operating system, or a hypervisor. At least one virtual machine is created on the BCP, the virtual machine is provided with virtual access to the security processor on the BCP.

### BRIEF DESCRIPTION OF THE DRAWINGS

FIG. 1 is a block diagram that shows an example chain of trust that can be used to verify a computing system;

FIG. 2 is a block diagram that depicts stage verification engines and policies for verifying a computing system in accordance with an example embodiment;

FIG. 3 is a block diagram of an example Trust Access Monitor Protection Architecture in accordance with an example embodiment;

FIG. 4 is a block diagram that shows a verification that includes a hypervisor in accordance with another example embodiment;

FIG. 5A is a system diagram of an example communications system in which one or more disclosed embodiments may be implemented;

FIG. 5B is a system diagram of an example wireless transmit/receive unit (WTRU) that may be used within the communications system illustrated in FIG. 5A;

FIG. 5C is a system diagram of an example radio access network and an example core network that may be used within the communications system illustrated in FIG. 5A;

FIG. 6 is a block diagram that shows an example of load-time validation;

FIG. 7 is a block diagram that shows an example relationship between protected entities, trusted reference values (TRVs) and platform configuration registers (PCRs);

FIG. 8 is a block diagram that show, among other things, an example of various measurement target storage areas;

FIG. 9 is a view of an example architecture that correspond to the system depicted in FIG. 4; and

FIG. 10 shows an example of inserting Global Offset Table (GOT) and Procedure Linkage Table (PLT) data pages and making them read-only.

### DETAILED DESCRIPTION OF ILLUSTRATIVE EMBODIMENTS

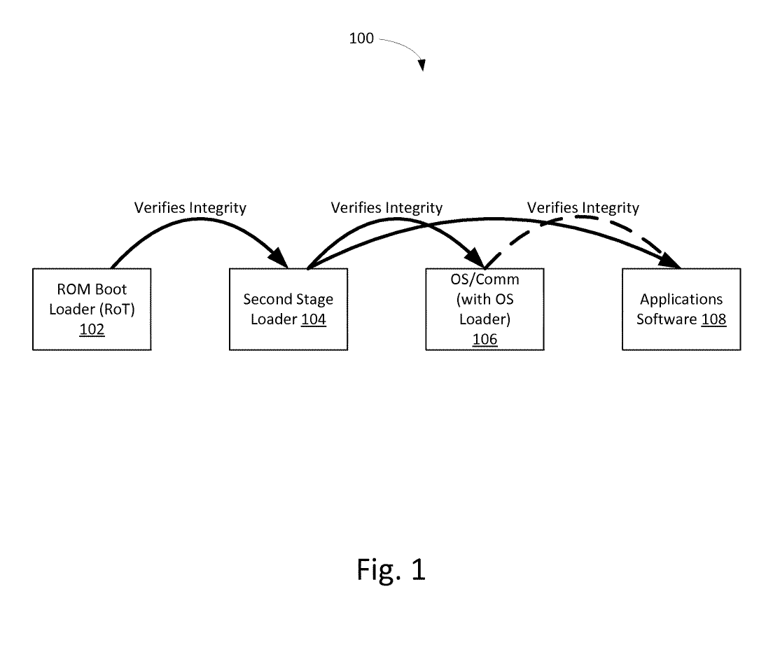

Described herein are methods, devices, and systems that provide security to various computing systems, such as, presented by way of example and without limitation, smartphones, tablets, personal computers, computing servers, distributed computing systems, or the like. Security is provided to computing systems at various stages of their operational cycles. Example stages include start-up, the stage in which an operating system is securely loaded and activated, the stage in which a run-time environment for applications is securely established, and the stage in which essential application programs and libraries are securely loaded and protected during run-time operation. A secure boot process may be the foundation of an integrity validation procedure. In an example embodiment, a chain of trust is initiated by an immutable hardware root of trust (RoT) that verifies the validity of the initial code loaded, and the boot process continues as each stage verifies a subsequent stage through the chain of trust (e.g., see FIG. 1).

It is recognized herein that technologies exist today to enable various collaboration systems to be deployed, but scalable security controls and tools are lacking. Such security controls and tools may provide various stakeholders with a level of trust and assurance that the stakeholders require. In addition, or alternatively, such security controls and tools may be required to drive a service delivery and communication ecosystem, such as a cloud based network communication system or an Internet of Things (IoT) service delivery system for example, to ensure continued reliable operation of its services, communications and computing capabilities. Thus, it is recognized herein that there is a need to establish trust in various aspects of a service, for instance in the end user devices, the network nodes, and cloud infrastructure, to enable a trusted ecosystem. Further, it is recognized herein that in light of the breadth of connected devices available on the market and the broadening range of products available that have embedded wired/wireless connectivity (e.g., consumer products, machine-to-machine (M2M) devices), the need for a scalable platform security solution that addresses security of various communications, user devices, and cloud servers is amplified.

On the other hand, the trustworthiness of the virtual machines forming a cloud, and the programs running therein, which process cloud consumers' data, is a largely open question. Trusted Computing methods can be used to secure the underlying physical platform through a trusted startup (or, trusted boot) process in which all started components are measured using cryptographic hash values. Trusted boot typically extends at most to the host operating system (OS) of the platform. Currently, the Trusted Computing Group discusses the specification of a virtualized platform standard, which shall allow extension of trusted boot to virtual machines, including the instantiation of multiple virtual Trusted Platform Modules (TPMs). However, this solution is rather complex since it requires full conformance to TCG procedures from all guest virtual machines and definition of trust relationships between virtual machines and physical platform (and its TPM). Further desired security related functions are the remote validation of the trustworthiness of a virtual platform and the programs running on it. Those advanced functions are only partially in scope of trusted computing technology, by way of remote attestation procedures, and Trusted Network Connect specifications. Those specifications are, however, not specifically adapted to the requirements of virtual computing platforms. Currently, there is no easy way to inspect a virtual machine for its trustworthiness, validate the programs running on it, and perform software updates on it in a common, secure way.

In accordance with an example embodiment, a trusted computing enabled security system, which may include a trusted computing enabled platform, is described. The computing system includes a ‘chain of trust’ anchored on an immutable root of trust component. The chain of trust is used to provide security for a platform by ensuring the integrity of low level operating system components to high level applications and libraries. As each firmware, software or data component is loaded on the computing system, the newly added component is verified for its integrity and trustworthiness. Subsequently, the state of the platform of the computing system is continually assessed during run-time. For example, the state of the platform may be assessed when memory is dynamically managed to swap code and data in and out of system memory. An integrity verification may cover various, for instance all, code and data. Code and data that may be verified includes, presented by way of example and without limitation, boot code, OS/Kernel, drivers, applications, libraries, and other data.

At the center of an example trusted computing enhanced platform is a Security Processor (SecP) and a Trust Access Monitor (TAM), which check the authenticity and integrity of software components (e.g., code and data), enforce access control policies, and provide an execution environment in which loaded applications, and data on which the loaded applications operate, are safe from tampering. Such data may be sensitive data. As used herein, the terms components and segments may be used interchangeably without limitation, unless otherwise specified.

Currently there are discrete components which can be used to ‘secure’ software components and data. But it is recognized herein that these discrete components are not enough to secure a complete computing system, which can be referred to generally herein as simply a system. Combining a few discrete components might not secure the system. Instead, an example secure system described herein has security designed into the architecture of the platform of the system. System security may be determined by the weakest link. If there is one design layer within a system that is ‘insecure’, then the entire system's security may be at risk. An example architecture that is described below includes a complete secure execution and storage environment that includes various security functions, such as, for example and without limitation: cryptographic capabilities, code and data integrity checking, access control mechanisms, and policy enforcement. Thus, the secure execution and storage environment can be referred to herein as a trusted computing environment.

Virtual machine, hypervisor, and container technologies may offer promise in terms of providing a trusted computing environment to host code and data, and in terms of isolating such code and data from various processes performed on a computing platform. However, the platforms typically rely on a software based trust anchor, which is often the weakest link in the security of such platforms. Various enhancements to computing platforms that build on capabilities of virtual machine, hypervisor, and container technologies are described herein so that an immutable trust anchor protects a platform at start-up and during run-time to ensure trustworthy operation at all times.

In one embodiment, a chain of trust validates code and data components on a platform, from start-up to run-time operation, such that the chain of trust covers not only the boot process of a platform and operating system, but also the operational run-time operations including, for example, validation of shared libraries and applications when they are loaded and executed. Dynamic reference measurement values are created and stored. Such values may be directly related to an integrity check that is performed upon initial loading, and such values may enable run-time checking of a system. The chain of trust for validation may be tightly integrated with secure memory management and access control through a central entity, such as the TAM for example. The central entity may be controlled by flexible policies, wherein the policies are also part of the chain of trust.

In another example embodiment, a load-time validation of a component (e.g., code and data) is securely bound to a run-time validation, for example, using the secure memory access control in the context of typical system memory management functions. Code and data may be continually protected through dynamic reloading, which may occur when lesser-used code and data are unloaded to create space for new code and data (e.g., dynamic memory management in the form of page swapping and caching) and during run-time as dictated by security policies.

In some cases, as boot-time attestation takes place, before a hosting service starts to host virtual guest applications, communication of the attested capabilities will need to be relayed to a third party (such as an “attestation authority”) with which the hosted application, once it is provisioned, has a two-way trust relationship. The act of a host service attesting itself to the attestation authority may set up a trust relationship between the two entities. There may be multiple attestation authorities residing in different trust domains within the host service. Subsequently during run-time operation of the host platform, the attestation service may continue to provide assurances of trust to guest users and attestation servers through a continuous attestation process. As an illustrative use case example for a virtualized communications system, the main Network Function Virtualization (NFV) function's deployed attestation authority may be under the control of the hosting operator. The trust domain management and orchestration service and the attestation authority may provide information to guests, owners or operators of third party hosted services (e.g., a multi-vendor or multi-tenant use case).

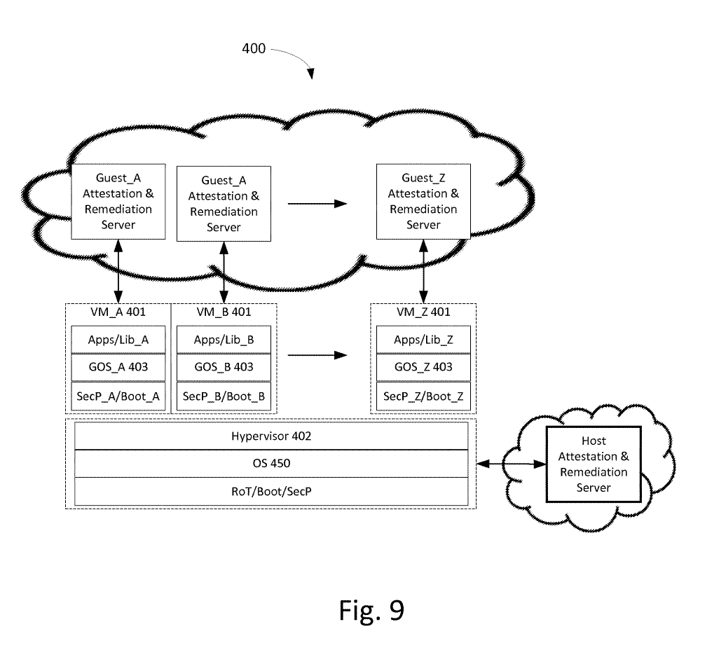

When a host OS to a hypervisor/virtual machine (VM) layer are brought up, and possession of a pristine VM is handed to a guest user/owner of a VM, a Trusted VM manager may be included in the process. In some cases, the trusted virtual machine (VM) manager may provide an abstraction layer for communications with a guest attestation server that performs remote management of a guest VM or attestation authorities that may cater to multiple stakeholders. The Trusted VM manager may provide for a deep attestation (bare metal) of the host platform, thus providing assurance to a guest VM user (and a guest attestation server, e.g., see FIG. 9) of the state and integrity of a host platform and its ability to maintain isolation of computing operations and storage (e.g., data storage), within the VM, from other guest VMs and the host computing platform. The attestation may be provided during startup and during run-time operations of guest virtual machines. In some cases, the Trusted VM manager may provide an abstraction layer for virtualized access to the SecP functionality on the host platform. The Trusted VM manager may include management infrastructure to provision virtual access to the SecP, or to take ownership of the virtual TPM and provision attestation keys. The Trusted VM manager may provide virtual PCRs to the guest VM, such that a single SecP with TPM functionality is not burdened with the processing of too many (e.g., thousands) of virtual SecPs. The Trusted VM manager may ensure that the guest VM can measure and maintain the integrity of the guest OS and Applications running in the VM.

As described above, a secure boot process is often the foundation for an integrity validation procedure. Referring now to FIG. 1, in accordance with the illustrated example, a chain of trust 100 is shown for an example device. The chain of trust 100 is initiated by an immutable hardware root of trust (RoT) that verifies the validity of the initial code loaded. The boot process continues as each stage verifies a subsequent stage through the chain of trust 100.

Still referring generally to FIG. 1, following power up and hardware initialization procedures, the device initiates a secure boot process. An initial RoT 102 or boot loader 102 may reside in encrypted form or secure read-only memory (ROM) of a given system platform and bound to that platform, and thus the RoT 102 may also be referred to as a ROM boot loader 102. The boot loader 102 may initially execute one or more initialization functions. The boot loader 102 may have access to a security credential (e.g., fused keying information) that the boot loader 102 uses to verify the integrity of a second stage boot loader 104. The second stage boot loader 104 may reside in external memory. The second stage boot loader 104 may be checked by hardware or software cryptographic means to ensure its integrity. In some cases, a computed measurement is compared to an expected cryptographic integrity measurement, which may be referred to herein as a trusted reference value (TRV). The TRV may be signed or encrypted and stored securely in external memory. If the computed measurement matches the TRV, then the second stage loader 104 is verified and may be loaded into internal memory (e.g., RAM). Accordingly, the boot loader 102 may jump to the start of the second stage loader 104 and the chain of trust 100 may continue.

The second stage boot loader 104 may contain code for a trusted execution environment (TrE) based measurement, verification, reporting, and policy enforcement engine that checks and loads additional code to internal memory. As used herein, the TrE may also be referred to as a Security Processor (SecP) or a TAM, without limitation. In some cases, the TrE establishes a trusted environment and secure storage area where additional integrity reference values can be calculated and stored. Furthermore, in some cases, the SecP integrity checks, loads, and starts operating system (OS) code 106. The example chain of trust 100 continues as each verified stage is checked and loaded to the applications code and data 108.

In some cases, the key to maintaining a chain of trust rests on the ability of the executing process to securely verify subsequent processes. For example, the verification process may require both a cryptographic computational capability and TRVs. It is recognized herein that code that resides in external memory may be vulnerable to attack and should be verified before loading. In a simplistic example with no fine grained validation, the second stage boot loader 104 need only verify the remaining code as a bulk measurement.

Generally, as used herein, a TRV is the expected measurement (e.g., a hash of the component computed in a secure manner) of a particular component of an application or system executable image file. Validation may rely on a TRV for each component that is checked to be present, for instance in the executable image or a separate file, and loaded in a secure manner for integrity verification purposes. By way of example, it is described herein that an executable image file is post processed to securely compute the hash values (or TRVs) of components of the executable image file and to securely insert the computed TRVs into an appropriate section of the same object file or in a separate file. The TRV hash values are generated and stored securely, and made available to the SecP. In some cases, the TRV values are signed, for example, with a private key that corresponds to a public key of the manufacturer of the software/firmware or a public key that belongs to the platform and relates to the corresponding private key that is stored securely within the platform. It will be understood that other forms of protecting the TRVs may be used as desired.

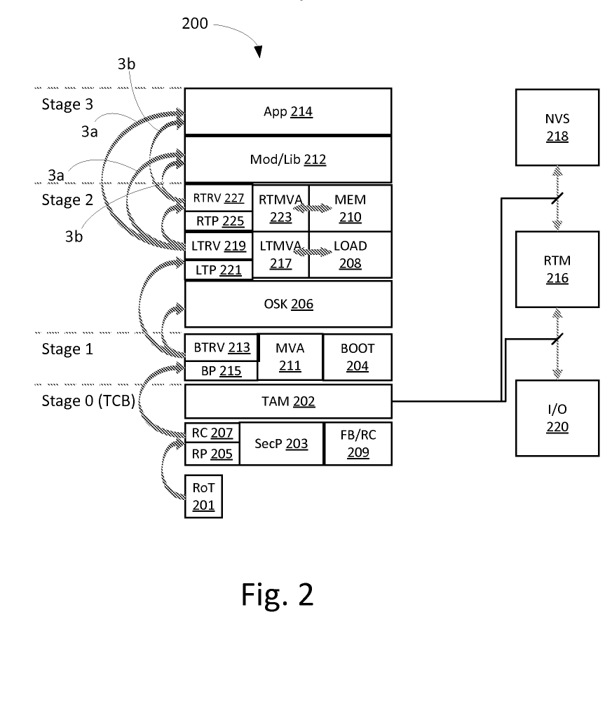

In accordance with an example embodiment, with reference to FIG. 2, a SecP 203 may provide both ‘chain’ based load-time and ‘run-time’ integrity verification. The SecP interoperates with various platform components such as, presented by way of example and without limitation, a Trust Access Monitor (TAM) 202, the MMU, loader(s), and virtualization, hypervisor, or container enablers. In accordance with an example embodiment, chain based verification starts with an immutable RoT. From there, future additions to the system are verified for authenticity and integrity before they are loaded on the system.

In some cases, referring to FIG. 2, the SecP 203 is at the center of the trusted computing enhanced platform. The SecP 203 and the TAM 202 may be responsible for checking the authenticity and integrity of software components (e.g., code and data) while also providing an execution environment in which the loaded applications, and any sensitive data they operate on, is safe from tampering.

Run-time verification may be classified into reload verification and dynamic verification. Reload verification may occur each time a code component or segment is reloaded after having been previously unloaded. Components may be unloaded due to various memory management functions, such as page faults, etc. Dynamic verification may occur continually during normal operation, regardless of processor activity. Dynamic verification checks provide protection against system alteration outside of the chain based load-time and reload verification. For example, dynamic verification may include checking a critical security sensitive function when it is about to be used, checking components at a periodic frequency based on configured security policies, checking components stored in read/write memory or the like.

In accordance with an example embodiment, the TAM 202 includes a loader with security enhancements. A function of the TAM 202 is to provide access control to resources on the system such as non-volatile, static, and/or dynamic memories, I/O ports, peripherals, etc. The TAM 202 may also enforce policy. Another function of the TAM 202 can be referred to as an enhanced loader function, to bring program components from external to internal memory. As shown in FIG. 1, a given chain of trust 100 may rely on each loaded stage of code being verified by the previous stage starting from a RoT 102 and the boot loader 102. The second stage loader 104 verifies the next stage including the core of the trusted environment and the OS loader 106. Once the OS is initialized and running, the remaining integrity checks are performed as part of the proposed enhancements to any standard OS loader. For convenience, example concepts described herein assume that the executable image can be completely loaded into RAM without the need for caching. It will be understood that these concepts can be extended to include more constrained cases, for instance where the executable image is larger than the available RAM. For example, cache memories may be used or the code may be executed directly from ROM.

The example loader may also place code and data that requires protection into memory designated as read-only. Thus, once a component has been integrity checked and placed in memory, the component cannot be modified by malicious software components and therefore does not normally need to be re-checked. Alternatively, inspection of header information in the executable image file followed by modification of the header information and other fields in the executable file can inform the loader to use read-only system memory for components which previously may have been placed in read/write system memory.

The loader example that brings code from external to internal memory may also perform cryptographic integrity checks. The integrity checking may reference back to cryptographic functions that may be securely held in the TrE. Under an example normal operation, the loader copies the component code and data segments to internal memory as identified by the header information in an executable image file. The header information may provide the start address and size of the components. The loader can compute an integrity measurement for a specific component and locate the associated TRV for the component, which may have been brought in previously and stored securely. The measured value may be compared to the stored “golden reference” TRV for the same component. If the values match, for example, then the code may be loaded into internal memory and activated for use. If the integrity measurements do not match, in accordance with one example, the code is not loaded and/or is quarantined or flagged as untrustworthy. For example, a failure may be recorded for that component and reported to the policy manager for further action.

Loader verification results for each component can be stored in fields indicating that the component has been checked and that the component passed or failed. When a functionality comprising one or more components has been checked and moved to internal memory, the policy manager can determine whether the full component load can be considered successful, and therefore whether the component is activated for use. For example, the loader may be provided with access to a secure memory location to track the integrity results.

In some example systems where code swapping may occur, and less frequently used code may be unloaded (e.g., by a garbage collector) and later re-loaded when needed, it may be necessary to re-check the code blocks that are being brought back into internal RAM. A subcomponent code block may be a part of a larger component with an associated TRV. If no block level TRV is available, for example, it is recognized herein that an integrity check of the entire component would be required each time a specific subcomponent block is required to be re-loaded. This requirement would add unnecessary computational burden on the system. In accordance with an example embodiment, a component is divided into its subcomponent blocks and intermediate TRVs are computed. The intermediate TRVs may be used to check the integrity of each block. Furthermore, a minimum block size can be implemented to compute an intermediate hash, such as a page for example. TRV hash generation of subcomponents is identified herein as TRV digestion to create run-time TRVs (RTRV). For example, a small subcomponent block's hash can be computed based on a memory page block size. Division of a component into subcomponents can occur when the component is integrity checked as part of the installation or start-up process, and the generation of RTRVs may be carried out at the same time. In accordance with one example, the RTRV data is stored in a Security Access Table that is accessible by the Trust Access Monitor 202.

The Security Access Table can be enhanced with additional informational elements to track whether the integrity of a component has been integrity checked. The Security Access Table may also include results of integrity checks that have been performed on components. The Security Access Table can be used to update the status of RTRV information for each checked component block that is loaded into internal RAM. In an example embodiment, after a component is fully verified and compared to its own TRV, then the RTRV information for each block in the Security Access Table is considered correct and usable for run-time integrity checking. The RTRVs are therefore bound to the component's TRV and to the successfully loaded and validated component.

The Security Access Table may be a central data point for access control, integrity checking, and validation of code during run-time, and it can be useful for several expanded security functions, such as, presented by way of example and without limitation:
Secure run-time trusted reference values (RTRV) storage, in which RTRVs may be dynamically generated when a component is loaded and use-enabled when the component is verified. Alternatively, the RTRVs may be loaded from file.
Enabling integrity verification of code and data at initial load-time and at run-time during reload or during dynamic verification.
Host processor read accesses, in which host processor read accesses to memory or peripherals may be passed through the Security Access Table. Such read access may indicate, for example, that a block is not in system memory and needs to be re-loaded and checked. The block may then be read from external memory, processed by the appropriate security function (e.g., SecP) and verified for its integrity. Alternatively, the block may be held in an encrypted form on the file system, in which case the block may be decrypted as it is read and brought into internal system memory.
Security maintenance/restoration, which also refers to restoration of security or remediation. For example, if an ‘identified’ component has been flagged as ‘unsecure’ during load-time or run-time checking, it may be remediated instead of performing a complete FLASH image restoration. In modern computing devices, this single image update file replacement may save the re-installation of one or more, for instance hundreds, of applications that may have been previously installed.

In accordance with an example embodiment, with reference to FIG. 2, the operational cycle of a given computing system 200 is secured in a complete manner, using an example chain of trust in which one level of trusted entities validates the next level before the next level is allowed to start. The range of the chain of trust includes the stages generally referred to as system start-up and operation. At an initial start-up stage, which is illustrated in FIG. 2 as stage 0, only essential trusted system components are active. Those components are inherently trusted and form part of the Trusted Computing Base (TCB) of the system, which can also be referred to as the base computing platform (BCP). During a main start up stage, which is illustrated in FIG. 2 as stage 1, trusted software or firmware components are activated. Such components may include, for example, a boot loader (BOOT) that is responsible for loading and starting the operating system. During an operating system start-up stage, which is illustrated in FIG. 2 as stage 2, an operating system kernel (OSK) 206 and security critical software components, for instance system program loader (LOAD) 208 and memory manager (MEM) 210, are loaded. During an application loading stage, which is illustrated in FIG. 2 as stage 3a, the OSK 206 is operational and LOAD 208 dynamically loads and starts OS (kernel) modules, systems libraries and other shared libraries 212, and application programs 214. During an application run stage, which is illustrated in FIG. 2 as stage 3b, applications 214 are running in the normal OS environment and application code and data may be dynamically managed. Some lesser-used applications or libraries may be unloaded by MEM 210 from run-time memory (RTM) 216 (e.g., the system's random access memory) to make room for new applications or libraries that may be loaded from non-volatile storage (NVS) 218 (e.g., a hard disk or flash memory).

It will be understood that the methods and system architecture concepts described herein can be implemented using various computing platforms and architectures, including, but not limited to, smartphones, tablets, personal computers, and computing servers (local or in the cloud). Some platform architectures, such as the computing platforms from Intel or HP for example, may support the disclosed functionality through small enhancements. Other platform architectures may require implementation of more extensive enhancements. In the following example that is described with reference to FIG. 2, validation of a first component by a second component (e.g., a measurement and validation agent (MVA 211)) includes taking a measurement value of the first component (e.g., via a cryptographic hash value) and comparing the measurement value against expected hash values or trusted reference values (TRVs). Depending on the outcome of the comparison, the MVA 211 may take an action. For instance, the MVA 211 may take an action to allow execution to proceed to the next stage if the check was successful. Alternatively, the MVA 211 may take an action to remediate an invalidated component in accordance with applicable policy.

Referring again to FIG. 2, in accordance with one example, Stage 0 is started by a Root of Trust (RoT) 201. In the example, the RoT 201 is an immutable, trusted element, which cannot be prevented from being started when the system 200 is initialized or modified in behavior or function. In some cases, the RoT 201 does not have its own computing capabilities. The RoT 201 may activate and hand control over to a security processor (SecP) 203. In one example, the RoT 201 may be generally referred to as a base computing platform (BCP). The SecP 203 may be a separate processor that operates inside a trusted environment (TrE). The SecP 203 may provide resources that are isolated from the remainder of the system 200. The SecP 203 may be verified and instantiated on the BCP. Such resources may comprise an isolated processing environment, memory, and a cryptographic coprocessor, for instance.

The SecP 203 may perform the main task to activate the Trusted Access Monitor (TAM) 202. In accordance with one example, the TAM 202 is a central security control on the system 200 and is, in particular, able to control and gate access to non-volatile storage (NVS) 218, run-time memory (RTM) 216, and input/output components (I/O) 220. The TAM 202 may operate based on policies defined and set by various authorized parties, i.e., system components, such as the SecP 203 for example.

In some cases, the SecP 203 loads its root policies (RP) 205 and root credentials (RC) 207 into its TrE. The SecP 203 may also load a fallback and remediation code (FB/RC) 209 into the TrE. The FB/RC 209 may be executed by the SecP 203, when any of the described-herein validations for example, performed by the SecP 203 on another component, fails. Additionally, the SecP 203 may validate RC 207, RP 205, and FB/RC 209, for instance using digital signatures and a certificate of a trusted third party, which is part of the RoT 201, before starting the procedures described herein.

In accordance with the example, the SecP 203 then validates stage 1 components and data, for instance the main measurement and validation agent (MVA) 211, the boot loader (BOOT) 204, and their associated trusted data, such as boot time trusted reference values (BTRVs) 213 and boot time policies (BP) 215 for example. Validation that is described herein as being performed by the SecP 203 may be performed using appropriate RCs 207, for instance by verifying digital signatures over the mentioned component code and data, in which case the RC 207 may be implemented as a digital certificate of a trusted third party. This can be advantageous in comparison to validation against a static hash value because, when using digital signatures, the signed components can be updated by a signed update package.

In some cases, when any of the validations fail, the SecP 203 may execute FB/RC 209 to perform remediation actions according to the RP 205. When validation succeeds, the SecP 203 may load MVA 211 and BOOT 204 into RTM 216. The SecP 203 may then configure the TAM 202 to protect the MVA 211 and BOOT 204 in the RTM 216 according to the RP 205. For instance, such a policy may prescribe that MVA 211 code is write-protected in the RTM 216 for the entire operational cycle of the platform. The policy may further prescribe that BOOT 204 is write-protected RTM 216, and BOOT 204 itself is able to remove the write protection on its own code space in the RTM 216. That is, after BOOT 204 has performed its task of loading the OSK 206, it may remove the write protection on its code and hand over execution to the OSK 206. In accordance with one example implementation, only then may OSK 206 use the MEM 210 to free up the memory space previously occupied by BOOT 204, and use it for another purpose. Furthermore, the TAM 202 may write-protect BTRV 213 and BP 215 on disk persistently, so that, for instance, this write-protection survives a “warm boot” of the system 200, where it may be assumed that stage 0 remains active and is not re-initialized during a “warm boot”. In some cases, the TAM 202 may reserve working memory in the RTM 216 for exclusive read/write access by BOOT 204 and MVA 211.

Continuing with the above example, after the above-described security configuration is completed, the SecP 203 may hand over execution control to stage 1 components BOOT 204 and MVA 211. During the main start-up phase, the MVA 211 performs validation checks on stage 2 components, as prescribed by BP 215 for example. For such checks, the MVA 211 may use the reference values BTRV 213. The MVA 211 may validate the OSK 206, LOAD 208, a load-time MVA (LTMVA) 217 and its associated data (e.g., load-time TRVs (LTRVs) 219 and load-time policies (LTP) 221). Additionally, the MVA 211 may validate a run-time MVA (RTMVA) 223 and the MEM 210, as well as available run-time policies (RTP) 225 and run-time TRVs (RTRV) 227. In one implementation variant, all the aforementioned validated stage 2 components may be part of the OS kernel 206 or kernel modules loaded by BOOT 204. The LTMVA 217 may perform an integrity measurement of a target component and compare the measurement against a reference “golden” expected measurement at the time of their first loading into working memory.

After validation, which may include remediation of a failure, the MVA 211 may hand over to BOOT 204 to start the platform OSK 206 and other components of stage 2. Before this, for example, the MVA 211 may configure the TAM 202 to protect the validated stage 2 components in a way that is analogous to the above-described validation of stage 1 by the SecP 203. The MVA 211 may follow the prescriptions in the BP 215 for the details of the TAM 202 security configuration.

In accordance with an example, at stage 3a, the LTMVA 217 performs validation on the dynamically loaded kernel modules system and shared libraries (Mod/Lib 212) each time they are loaded, as requested by a system call to LOAD 208. In some cases, the LTMVA 217 uses LTRVs 219 and LTPs 221 for validation and remediation, respectively, in an analogous manner to the validation and remediation procedures of the earlier stages. As shown, FIG. 2 depicts an overview of an example system architecture 200 and the above-described start-up stages. As shown, the curved arrows depict the chain of trust. In particular, the curved arrows illustrate which reference values and policies may be used to validate particular trusted components and data at a higher level of the chain of trust.

In accordance with an example embodiment, validation at stage 3b (e.g., during proper run-time of an application (App) 214 or a Mod/Lib component 212 that previously—before load—has been validated by the LTMVA 217 at stage 3a, may differ from the above-described methods. In some cases, stage 3b validation is integrated with the protection policies executed by the TAM 202 on running Apps 214 and Mod/Lib components 212. The below description includes a consideration of operations on the smallest segments of RTM 216, which are often referred to as pages, although it will be understood that the described operations can by be applied to any code or data segment as desired.

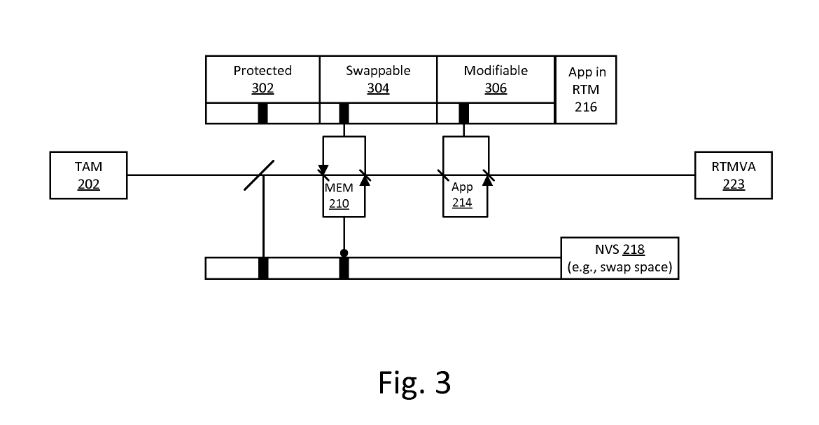

Referring also to FIG. 3, in accordance with the illustrated example, different policies can be associated with different segments of code that are subject to run-time validations. Such policies may be enforced by the TAM 202 and the code may be associated with a validated application 214, for example. The different segments of code may include, for example, protected code 302, swappable code 304, and modifiable code 306. In some cases, protected code 302 is write-protected by the TAM 202, and cannot be modified in the RTM 216. As indicated by the gate control “deny” symbol (/) in FIG. 3, a request to write a page of protected App code may be denied by the TAM 202. In some cases, swappable code 304 may be requested, by the MEM 210, to be removed from the RTM 216. Swappable code 304 may be stored in the NVS 218, for example, for system memory management. As indicated by the gate control “allow” symbol (\) in FIG. 3, the TAM 202 may allow swappable code 304 to be removed from the RTM 216 and stored in the NVS 218. In some cases, modifiable code 306 may be swapped and modified. For example, modifiable code 306 may be replaced with another piece of the RTM 216 according to a request of an authorized process, for instance the App itself, in which case the App code is allowed to be partly self-modifying. It is recognized herein that self-modifying code is less common in compiled high-level programming languages, but more common in assembly language and interpreted, or just-in-time compiled, high-level languages. One example is the “reflect” API of the Java language.

With respect to swappable and modifiable code 304 and 306, respectively, the RTMVA 223 may be required to ensure the integrity of the swapped/modified pages. For example, in some cases, the RTMVA 223 may ensure the integrity of a page for which the MEM 210 requests swapping out of the RTM 216 to the “swap space” on the NVS 218. The RTMVA 223 may be called (by TAM 202 or MEM 210) and may create an RTRV 227 for the page, for example by measuring the page using a cryptographic hash function (symbolized by a downward arrow in FIG. 3). Then the page may be written to the NVS 218 or discarded, and the MEM 210 may free the memory space in the RTM for another purpose.

Still referring to FIG. 3, in accordance with the illustrated example, when the page is “swapped back in” (e.g., MEM 210 requests that the page is loaded back into RTM 216 at the same location as it was before or another location), the RTMVA 223 is called again and validates the page residing on the NVS 218 against the RTRV 227 created at the time of swapping out (symbolized by an upward arrow in FIG. 3). At the same time or at an instant before the validation, the TAM 202 may enforce write-protection on the page in the NVS 218, for example, to provide additional protection against tampering in the time between validation and the actual loading of the page into the RTM 216. When validation succeeds, for example because the page was not tampered with in the NVS 218, the MEM 210 may load the page into the RTM 216.

Similarly, with respect to a modifiable page of the code of a given App, in accordance with an example embodiment, the RTMVA 223 may validate the modified page at the time in which it replaces the old page in the RTM 216. Validation in this case may be different from a simple comparison to a RTRV 227, for example, because the modifications that are considered admissible may be complex and manifold. In some cases, the RTMVA 223 may apply an RTP 225 on the modified page to validate it. For instance, and without limitation, such a policy may prescribe a validation against a multitude of admissible LTRVs 219 for the page, a check for malware signatures in the page, or a check of the entity that performs the code modifications and a check of compliance to the rules that are followed for the code modification.

In an alternative embodiment, the RTRVs 227 may be generated for an entire image load during the load operation, for the trust anchored on the security, and for trust of the load time validation against LTRVs 219. These RTRVs 227 may be stored to be used later to check the integrity of pages brought back in to RTM 216 during run-time. In this example, the generation of the RTRVs 227 is under the sole control of LTMVA 217, which may increase system security by strengthening the chain of trust connection between the LTRVs 219 and the RTRVs 227 (symbolized by an arrow connecting both in FIG. 2). With respect to the implementation of this variant, the LTMVA 217 may perform its core task of validating a component and specified (by LTP 221) pieces of data, on the NVS 218 (e.g., a hard disk), against their LTRVs 219. In this variant, validation may be tightly combined and performed concurrently with the loading of the component and creation of the corresponding LTRVs 219. These processes may be executed by, or under the control of, the LTMVA 217. The LTMVA 217 may determine the code and data segments of an application 214 when the loading of the application 214 is requested. In some cases, the LTMVA 217 then determines, possibly with the help of LOAD 208, the segments of library code and data that are linked to the Application 214. Such segments may be called by the application 214 during its execution. The previous determinations of segments of code and data that are to be validated may be governed by policies in LTP 221, individually for each application 214. The LTMVA 217 may then force the loading of the aforementioned segments into working memory, which is different than typical operation of operating systems.

During the loading, efficient mechanisms, which are described below, may be implemented to concurrently validate and create LTRVs 219. In one example embodiment, code and data segments are read, by the LTMVA 217, one memory word after each other. A memory word may consist of one or multiple bytes. The process of continuously reading memory words, by the LTMVA 217, is commonly referred to as streaming. The LTMVA 217 may feed the streamed memory words into an appropriate hash algorithm, such as SHA-256 for example. Specifically, the LTMVA 217 may collect memory words until a predetermined input length HL for the algorithm is reached. The working memory may consist of pages of a fixed length in Bytes (for instance 4096 Bytes), and these pages may be filled consecutively with the code and data loaded from the NVS 218. In some cases, it is assumed that the size of a page is a multiple N of a memory words. The HL may be determined to be this multiple N. Thus, the LTMVA 217 may read HL=N memory words W_1, . . . , W_N from NVS 217, and the LTMVA 217 may create the hash value H_k=Hash(W_∥ . . . ∥W_N), where Hash is the applied hash algorithm and “∥” denotes concatenation, and the subscript k signifies that the present Hash computation is to be placed in the k-th entry of the Security Access Table and associated with the page that was just read and measured. Then, the LTMVA 217 may load the collected memory words W_1, . . . , W_N into working memory. In accordance with the example, the H_k is now directly stored by the LTMVA 217 in the Security Access Table of the RTRVs 227 for the application 214, at index position k, which means that the RTRVs 227 of the application 214 is a table of hash values consisting of hashes representing exactly the hashes of specific memory pages.

Furthermore, in some cases, the H_k may also be used to iteratively generate a hash value over a complete segment of the application, which may then be compared to a LTRV 219 for load-time validation. For this, the LTMVA 217 may use hash-chaining on the H_k to obtain validation values V_k=Hash(H_k∥H_k-1) until the end of a segment is reached, and compare the final validation value against the appropriate LTRV 219.

If the size of a page does not match exactly the number of whole words required for a hashing algorithms, then zero padding might be performed to extend a page to an appropriate boundary that is suitable for the hashing algorithm.

If, in accordance with an alternative example embodiment, validation of the application 214 and loading of the application 214 is not done concurrently with each other, and the LTMVA 217 first validates and then initiates load of the application 214, measures may be taken to protect the application 214 between the above-mentioned steps. For example, the LTMVA 217 may make the above-mentioned application image on the NVS write-protected, for instance by installing a corresponding TAM policy, so that it cannot be tampered with during the process of loading it into working memory.

It may be preferable for the LTMVA 217 to make the generated RTRVs 227 write-protected in their storage locations, for instance by installing a corresponding TAM or operating system policy (as can be implemented, e.g., in the SELinux OS). In an example embodiment, such write-protection is under the authority of the LTMVA 217 and may only be removed by the RTMVA 223 when the application 214 is unloaded.

In some cases, for instance for flexibility, a TRV may be realized as digital tokens or certificates (e.g., credentials analogous to RCs) and the validation may be executed by checking signatures on the validated components.

Turning now to the validation of applications (VAPP) at the time of loading and at run-time, various components of a guest operating system (GOS) kernel, program loader, and memory management may be need to cooperate with each other. As used herein, the term VAPPs refers to measured or validated software on the GOS, and may comprise system libraries, which may be dynamically or statically linked with each other, and application software that is determined to be checked at load-time and run-time. As used herein, a GOS may include security critical portions that are validated by the MVA before the guest OS is loaded and started. As described above, the GOS may be the system kernel. Depending on the GOS system architecture, implementations may vary.

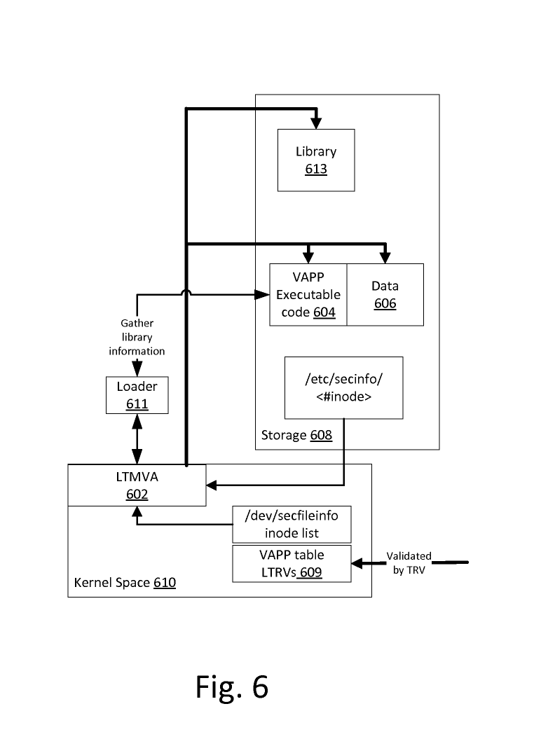

With respect to load-time validation, referring to FIG. 6, as a prerequisite for load-time validation, in accordance with the illustrated example, an LTMVA must be able to uniquely identify and locate executable code 604 and data 606 of VAPPs. In some cases, the required information is gathered at the time of installation of a VAPP. At this time, code 604 and data 606 of a VAPP may be downloaded from an external source, such as storage 608. The program may be identified by a globally unique identifier (GUID), by which the LTMVA 602 looks up a configuration table. The configuration table may be associated with the LTRV storage, and may be protected in a way that is analogous the storage of the data Conf associated with TRVs. In one example, if the LTMVA 602 finds an entry corresponding to the GUID of the program that is to be installed, it determines that this program is a VAPP which is subject to load-time and possibly run-time validation. When the system installs the VAPP, it is stored to non-volatile storage and assigned a unique storage location pointer. The LTMVA 602 may store this storage location pointer, which may be realized by an inode number of a Linux OS file system, in another table in a storage which is provided with a certain protection.

With continuing reference to FIG. 6, in accordance with the illustrated embodiment, the LTMVA 602 may be part of a GOS kernel or a kernel module, which can be referred to generally as a kernel space 610, so that its code is validated by the foregoing secure startup procedure. The kernel implements, at startup of the kernel, a special LTMVA device, for instance named /dev/secfileinfo according to the illustrated example, which may be exclusively accessible by the LTMVA 602. The critical data of the LTMVA 602, comprising LTRVs and the table of VAPP GUIDs for example, may have been validated earlier in the secure startup by MVA, as described above. The validated LTMVA data 609 (LTRVs and VAPP table) are written into the LTMVA device at startup of the GOS. At time of installation of a VAPP, an association of the VAPP's storage location identifier (e.g., inode number) to the GUID in the VAPP table is written to the LTMVA device.

When a process (e.g., another program or a user process via a command-line interface) requests the starting of a VAPP, a program loader 611 may determine the storage location pointer of the VAPP's code 604 and data 606 (e.g., inode number). The program loader 611 transmits this location pointer to the LTMVA 602 and hands control to the LTMVA 602. LTMVA 602 looks up the corresponding information in the LTMVA device, and in particular may retrieve corresponding LTRVs. The LTMVA 602 may then read supplementary data from a file in non-volatile storage, which is associated with the storage location pointer of the VAPP, for instance in a file path “/etc/secinfo/<inode number>” according to the illustrated example. Such supplementary information may comprise starting addresses and lengths of segments of code and data that are to be validated, as well as particulars of measurement algorithms to be used (e.g., hash algorithms). The LTMVA 602 may then find the VAPP code 604 and data 606, and validate it against the corresponding LTRVs (e.g., from LTRVs 609).

It is a common feature of modern operating systems that code is shared between application programs. Shared code is commonly placed into libraries. From a security viewpoint, it may be advantageous to include library code used by a VAPP in validation. For example, in accordance with an embodiment, when a process requests the starting of a VAPP, the program loader 611 or another entity, such as the dynamic linker for example, may inspect the relevant data in the VAPP that points to the parts of all shared libraries (for instance a library 613) which are used by the VAPP. The loader 611 may then transmit the storage location pointers (e.g., inode numbers) of the relevant shared libraries to the LTMVA 602, together with the pointer to the VAPP. The LTMVA 602 can then obtain TRVs for the shared libraries, for example portions of the shared libraries, from the LTMVA device (if available), and validate the shared library portions. The process of finding information about used shared libraries may, in an alternative example, be performed at the time of installation of a VAPP, and the relevant information may be stored in the LTMVA device for use at the time of loading the VAPP.

With respect to run-time validation, when a VAPP is loaded into working memory by the loader, the VAPP code and data may loaded into two distinct memory segments. In one example, a first memory segment is not writeable, and a second memory segment is readable and writeable. The first segment may contain executable code, for instance all executable code, of the VAPP that is designated to be subject to run-time validation. The second segment may contain data of the VAPP, which may change during its execution. Because the first segment is write-protected in accordance with the example, it is inherently secured against compromise. However, typical system memory management of a GOS includes swapping out or offloading parts (e.g., pages) of running programs when memory space is required by other programs. This may lead to circumstances in which a memory page of a VAPP code piece is offloaded from write-protected working memory to non-volatile storage. In such a case, a compromise of that swapped page might occur. Run-time validation provides a means of protection against the above-described threat. To enable run-time validation, the RTMVA functionality is integrated with the system memory management, for instance using a TAM as described above.

Turning now to handling location-independent and linked code, it is recognized herein that there may be specific issues related to location-independence of application (APP) code and location-independent dynamic linking of external (library) code to the program code of an APP, which are independent of the generating RTRVs as described above. As used herein, location-independence means that APP code does not include jumps to absolute location addresses in system memory, so that the loader is able to load the APP code into any memory location for which memory can be allocated, which is the basic pre-condition to enable dynamic memory management. Similarly, as used herein, location independence of linked library code means that the operating system can place shared library code anywhere in memory and that APP code is still able to use it, without “knowing” (e.g., without maintaining persistent addresses of such shared library code in its own code or data) the location of such shared library code.

In some cases, indirections are used. For example, the APP binary may contain two tables in its load segment (which is a data section), which may be referred to as a Global Offset Table (GOT) and a Procedure Linkage Table (PLT). When APP code calls a shared library procedure at run-time, it may do this through a stub function call in the PLT, which looks up an address in the GOT section, which in turn points to an entry point at the OS function called the dynamic loader. The dynamic loader may discover the actual procedure location, and may place it into the mentioned address in the GOT section. In some cases, the next time the function is called, the GOT section entry directly points to its absolute address, and it is immediately found. This strategy can be referred to as “lazy binding”.

It is recognized herein that the lazy binding strategy of memory management and code sharing may pose problems for validation and system security in general. For example, because the GOT and PLT sections may be modified at run-time, it might not be straightforward to create RTRVs for those such that modification of their contents at run-time will be possible. Thus, malicious code may modify the addresses and pointers in the GOT and the PLT. Alternatively, the address tables used by the dynamic linker may be modified, so that the dynamic linker itself puts wrong target addresses into the GOT while performing the lazy binding.

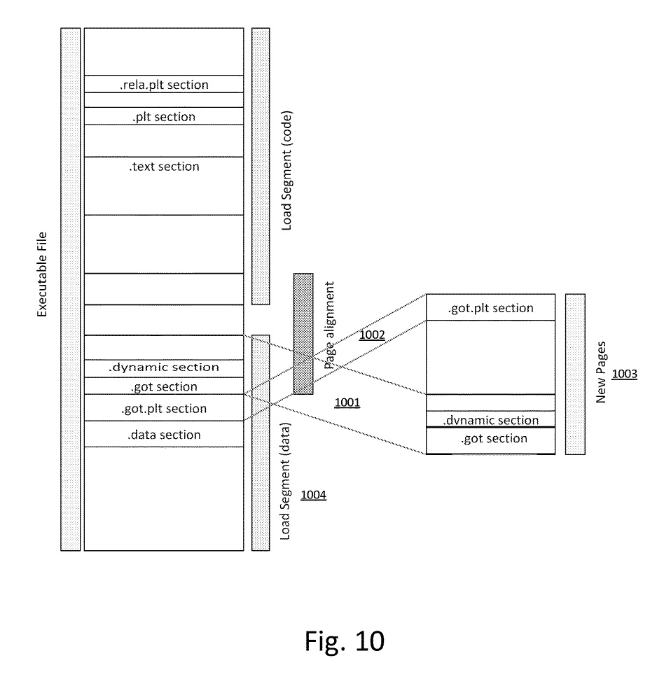

Referring to FIG. 10, in one embodiment the above-described security shortcomings associated with lazy binding are addressed. At load time of the APP, the loader processes all the indirect calls in the PLT section of the APP 1002. The dynamic loader is called to resolve the resulting calls to shared library procedures. If they are not present in memory, those library procedures are loaded and, at this point, also validated using their respective LTRVs. The new address information for the shared library procedures is inserted into newly created pages that are added in the data segment of the APP. GOT entries, for instance GOT entries 1001, are then modified to point to the respective locations in the newly added pages 1003, which in turn point to the absolute locations of the shared library procedures. In accordance with the above embodiment, persistent RTRVs for the GOT, PLT, and newly added pages containing the absolute linking addresses, may then be created. In the example, the data segment 1004 is then made read-only, so that it cannot be modified by an attacker.

Described above is a tight chain of trust that extends into the system run-time operation for standard computing architectures. As described below, the core concepts are generalized to apply to host platforms, in particular platforms that host multiple virtual machines as guest systems. These platforms provide a hosted virtualization environment for guests to install their own code and data with the assurances that the storage of code and data and the processing of code and data will occur in a secure and isolated manner from the host and other guest virtualization environments. Such architectures are often referred to as cloud services.

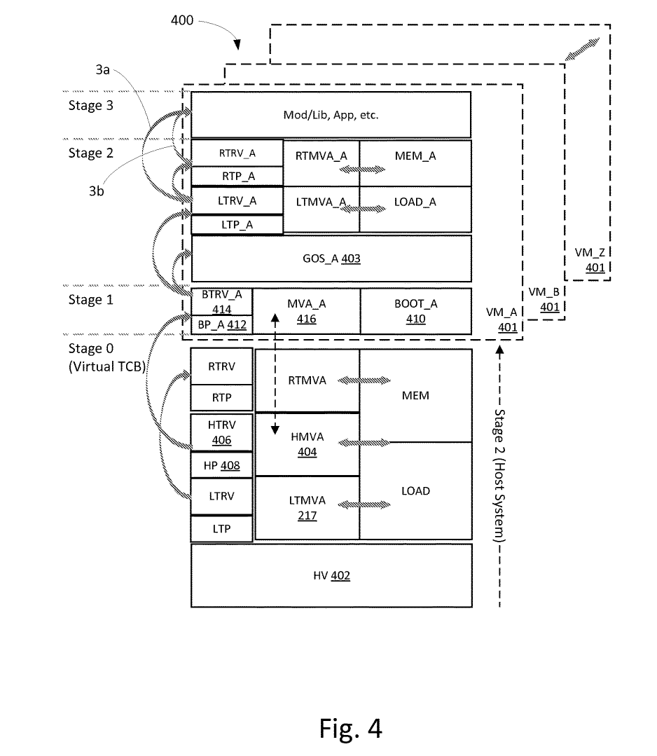

Referring to FIG. 4 and FIG. 9, the above-described implementations may be applied to computing systems, for instance an example system 400, which comprises a hypervisor (HV) 402, at least one virtual machine 401 (e.g., VM_A 401, VM_B 401 . . . VM_Z 401), or a container to protect content (e.g., OS, program code and data). In an example embodiment, referring also to FIG. 1, a chain of trust occurs that includes the hypervisor 402 as part of the underlying OS checks that are performed at Stage 2. In one example, a base computing platform includes boot code, an OS 450, or a hypervisor 402, and the boot code, OS, and the hypervisor can be classified as subsequent startup components of the BCP. For example, after a secure boot of the BCP is performed, the integrity of the subsequent startup components of the BCP is verified. Following the Stage 2 checks, the basic OS framework is in place to enable creation and protection of a virtual machine (VM) 401 that may host another OS (e.g., GOS 403), programs, and/or data that is isolated from other virtual machines (VMs). Similarly, a container may host program and data that is isolated from other containers and the host OS. It is recognized herein that VMs and containers follow a common architectural principle. For example, both VMs and containers reside inside an operating environment that hosts the guest systems. In the case of isolating environments based on VMs, the host environment commonly hosts a hypervisor (HV) management function, whereas for containers, the host environment supports “containerization”. Hypervisors and containers may isolate the guest operating systems and applications (and guest processes) from each other and the host, and may provide abstracted and virtualized access to system resources, such as, for example, the hardware based RoT, SecP, TrE, MVA, and TAM.

Referring to FIG. 4, an example system 400 is illustrated that depicts how the chain of trust 100 can be extended to VMs and containers, and to applications running therein. For simplicity, the example system 400 is described in terms of VMs, for instance at least one VM 401 (e.g., VM_A 401, VM_B 401, VM_C 401), running in an HV 402, though it will be understood that embodiments are not limited as such. It will be understood also that FIG. 4 does not necessarily depict the ordering of the load components, but is illustrative of various example functionalities in the host system. Referring to FIG. 4, in accordance with an example embodiment, validation resources are provided from the stage 2 validated components, which include the HV 402, to the start-up and operation of a virtual machine guest operating system (GOS) 403 (e.g., GOS_A 403, GOS_B 403, GOS_C 403) or a container. For this, the HV's may substantially help guest systems replicate stage 0 and stage 1 components (shown in FIG. 2), which may be a foundation for the equivalent of stage 0 and for taking ownership of a VM_A by a guest system in order to perform the equivalent of stage 1 within the VM (e.g., VM_A). These may be essential for the trusted start-up and operations of the GOS 403, and to provide security to the virtual resources of the guest systems. In accordance with the illustrated example, the LTMVA 217 and the RTMVA are augmented by a Hyper-MVA (HMVA) entity 404 to which hypervisor trusted reference values (HTRV) 406 and hypervisor policies (HP) 408 are associated as trusted data. In one example, after successful validation of the base components of the pristine VM_A 401, the HV 402 establishes a processing environment. For an example concrete guest system VM_A 401, which includes boot loader (BOOT_A), boot time policies (BP_A), boot time trusted reference values (BTRV_A, and GOS_A kernel, the HMVA 404 sets up a foundation for the VM_A such that the guest system may take ownership of a pristine VM_A. The HMVA provides the VM_A with a secure processing environment, secure storage, and secure virtualized interfaces back to the host anchored security components such as the SecP with its TPM, TAM, MVA functionality, etc. After the guest system successfully takes ownership of the VM_A, the guest system can independently establish the basic environment to provision credentials for such equivalent functions as the BOOT_A and may be a virtual SecP to replicate the equivalent of a secure load-time and run-time environment for the VM_A, which may be substantially similar, for instance the same, as previously described for a base platform. Furthermore, the HV 402 may establish a virtual SecP, which may be hosted within a TrE and which may comprise the TAP, TPM, MVA functionality. The virtual SecP may have an interface to the SecP inside the host environment. The SecP interface may provide a trust anchor for BOOT A and the virtual TAM that forms part of the virtual SecP. The SecP interface may establish an interface to the host platform's TAM to provide the VM_A 401 with support for secure access management to resources within the virtual machine VM_A 401. The HV 402 may then facilitate validation of the BTRV_A, BP, and BOOT_A against appropriate BTRV_As. The BOOT_A may then be started and proceed to validate and start MVA_A and GOS_A 403 in an analogous manner to the start-up of stage 2 that was described above with respect to FIG. 2. Additionally, the GOS_A 403 may comprise its own LTMVA_A and RTMVA_A, which may be validated and started to enable load-time and run-time validation of applications and libraries, as described above for the host system.

Thus, as described above, a secure boot of a base computing platform (BCP) may be performed, and the SecP may be instantiated on the BCP. Using the SecP, an integrity of the OS of the BCP may be verified, and an integrity of a hypervisor may be verified. A virtual machine may be created on the BCP. The VM is provided with virtual access to the SecP on the BCP. Using the virtual access to the SecP, an integrity of the guest OS of the VM is verified and an integrity of applications running on the guest OS are verified.

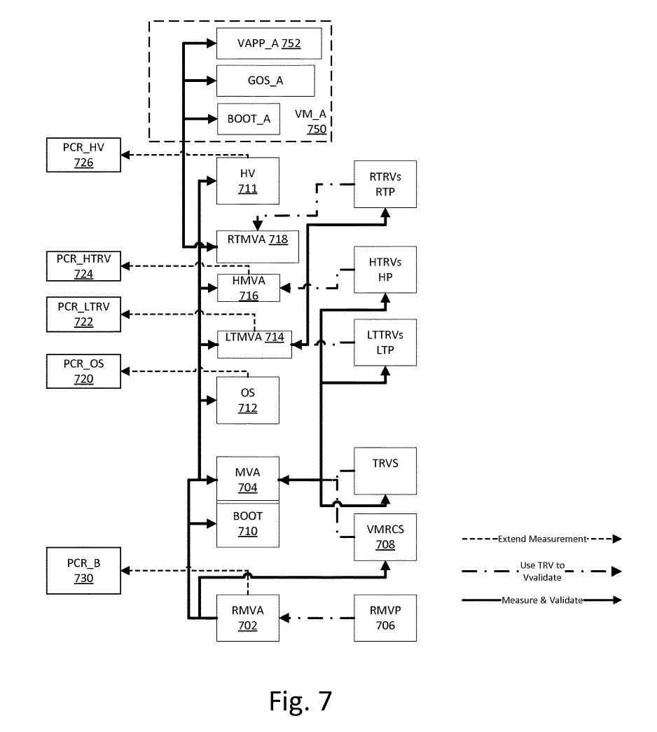

Referring now to FIG. 7, the relation of protected entities to TRVs and platform configuration registers (PCRs) will now be discussed. In some cases, only a Root Measurement and Validation Agent (RMVA) 702 and MVA 704 can write (e.g., extend into) dedicated PCRs, examples of which are described below. The RMVA 702 may be a secure entity that is started after static components of the platform are started and validated. The RMVA 702 may be invoked at an early stage of the start-up of the platform software, for example before the hypervisor or a guest OS is loaded. The RMVA 702 can measure and validate any other software and data on the platform. In this context, validation refers to comparing measurement values against TRVs, and taking a policy action in accordance with the comparison. The RMVA 702 may be similar to a DRTM of TC parlance, but the RMVA 702 may have its own computing environment, and the RMVA 702 may invoked at a certain point of the platform start-up to perform specific tasks, and then may be shut down again.

For example, at stage 0 (e.g., see FIG. 4), an RMVA Policy (RMVP) 706 may contain various TRVs, such as a TRV (TRV_B) of a System Boot Loader Component (BOOT 710), a TRV (TRV_VMRC) of root credentials for MVA authorities, and a TRV (TRV_MVA) of an MVA component. The RMVP may contain policies associated with what the RMVA 702 has to measure, TRVs, anything that needs to be validated, or actions to be performed up a successful or failed validation. The TRV_B may be a multitude of different TRVs for different boot loaders. At Stage 1, the RMVA 702 may use trusted data of the RMVP 706 to measure and validate the various components, such as, for example and without limitation, a Validation and Management Root Credentials (VMRC) Storage (VMRCS) 708 and contents therein using the TRV VMRC, a Boot loader component using TRV_B, and an MVA component using TRV_MVA. The VMRCS 708 may be non-volatile storage for VMRCs, which is writeable by the RMVA 702. In an example, the RMVA 702 extends into PCR_B the measurements of the VMRCS 708, boot loader, and MVA 704.

At Stage 2, in accordance with the example, the contents of the TRVs are measured and validated using appropriate credentials from the VMRCS 708. Each element (TRV) of the TRVs may have an attached integrity value and a label, by which the MVA 704 selects the appropriate root credential in the VMRCS 708, and then uses this credential to cryptographically verify the integrity value. The MVA 704 measures and validates the various components, such as, for example and without limitation, the OS 712, the LTMVA 714, the HMVA 716, and the RTMVA 718. The MVA 704 may measure and validate the OS 712 OS measuring and comparing the TRV_OS. The MVA 704 may extend the aggregate measurement value of the OS 712 components into the PCR OS. The MVA 704 may measure and validate the LTMVA 714 by measuring and comparing the TRV_LTRV. The aggregate measurement value of the LTMVA components may be extended into the PCR_LTRV 722. The MVA 704 may measure and validate the HMVA 716 by measuring and comparing the TRV_HTRV. The aggregate measurement value of the HMVA components may be extended into the PCR_HV 726. The MVA 704 may measure and validate the RTMVA 718 by measuring and comparing the TRV_RTRV. The aggregate measurement value of the RTMVA components may be extended into the PCR_RTRV.

Turning now to an example of a secure start-up procedure, in some cases, the RMVA 702 may assume unconditional and exclusive control over all program execution. For example, at stage 0, the RMVA 702 may read the RMVP 706 from NV storage. The RMVA 702 may measure the VMRCS 708, BOOT 710, and MVA 704, and the RMVA 702 may validate the measurement values against the respective TRVs contained in an RMVP.

In some cases, if any of the validations fails, the RMVA 702 executes a remediation action as specified by the respective policies in the RMVP. For instance, the RMVA 702 may halt the system, force a restart, or send out a distress alarm via an appropriate interface. In some cases, if the validations succeed, the RMVA 702 extends the measurement into PCR_B 730 and continues the start-up procedure. In an example, the RMVA 702 may make PCRs, for instance all PCRs in which it has extended measurements, non-writeable. At stage 1, the RMVA 702 hands over execution control to BOOT 710. The MVA 704 validates the contents of TRVs using credentials in the VMRCS 708, as specified above.

Using the contents of the TRVs, the MVA 704 validates the components as specified above (e.g., OS, HV, LTRVs, LTP, LTMVA, HTRV, HP, HMVA, and RTMVA). If a component fails validation, the MVA 704 takes an appropriate action, such as halting the system, forcing a restart in reduced functionality mode, sending out an alarm, or performing a remediation procedure as specified below. The MVA 704 may extend the measurement value of the OS 712 into PCR_OS 720 and make PCR_OS 720 non-writeable. The MVA 704 may extend the measurement value of the LTRV 714 into PCR_LTRV 722 and make PCR LTRV 722 non-writeable. The MVA 704 may extend the measurement value of HTRV into PCR_HV 726 and make PCR_HV 726 non-writeable. The MVA 704 may extend the measurement value of RTRV into PCR_RTRV and makes PCR_RTRV non-writeable. The MVA 704 may hand back execution control to BOOT 710. The BOOT 710 may load and start the OS 712. The OS 712 loads and starts the HV 711, LTMVA 714, HMVA 716, and RTMVA 718. Still referring to FIG. 7, the system may be continuously monitored during run-time with the assistance of the RTMVA 718.

At Stage 2, in accordance with the illustrated example, the HV 711 sets up, measures, and validates, a pristine VM 750 for a guest system. The HV 711 assists the guest system in taking ownership of the VM 750 and sets up a base condition similar to the description of Stage 0 above for the guest system. For example, applications and libraries (VAPP 752) are measured, loaded and validated by an LTMVA (LTMVA_A) using a corresponding reference values (LTRV_A). An RTRV may be created for each VAPP 752. An RTMVA may validate code and data of loaded VAPPS 752 using corresponding RTRVs. PCR measurements in the VM 750 can be extended appropriately by the guest system according to its own policies. In some cases, the VM 750 is continuously monitored during run-time with the assistance of the associated RTMVA.

Turning now to remediation and management, components that fail validation checks can be remediated or restored to pristine condition, in accordance with an example embodiment. The functional components of the system can grouped into three levels, which behave similarly with regard to remediation and management. When validation of a VAPP fails, LTMVA may take a remediation action according to policies associated with the corresponding LTRV. Examples of load-time validation and remediation are described below. When validation of a VAPP memory contents fails, RTMVA may take a remediation action according to policies associated with the corresponding LTRV. Examples of run-time validation and remediation are also described below. With respect to the 3 levels, level 0 may contain RMVA, and associated data is RMVP. Level 1 contains BOOT and MVA, and associated data is VMRCs. Level 2 contains HV, LTMVA, RTMVA, and GOS, and associated data is TRVs in TRVs and LTRVs. Level 3 contains VAPPS and associated data is RTRVs.

Remediation refers to correcting the functionality of a specific component, in full or in part, when a fault is detected. In turn, faults are detected, in the above-described system setting, when a validation of a component or associated data fails, e.g., when a measurement value fails to agree with the corresponding TRV. In some cases, level 0 components cannot be remediated automatically because no TRVs are available to validate them. In this cases, the system may halt and a distress signal may be sent out (if level 0 is compromised). Level 1 components and associated data are validated by RMVA using TRVs contained in RMVP. If a compromise of a level 1 component or associated data is detected then RMVA may initiate one of several remediation actions. In this case, three fundamentally different situations can be handled by different, respective, procedures as follows.

MVA is compromised. If RMVA detects a compromise of MVA then it may perform a series of remediation steps which escalate the reaction to the compromise. First, RMVA may check for the availability of a full replacement code image for MVA from a trusted (i.e., independently trusted from level 0 components and data) storage location, e.g., a ROM protected by e-fuses. If such a replacement image is available, RMVA may load it to the original storage location of MVA. Then, RMVA may set a protected flag, which is only accessible by RMVA, which indicates the state ‘MVA restored’. Then, RMVA resets the system into the state immediately before RMVA is normally initiated and hands over execution control to the normal system startup process. The purpose of this method is to detect the cause of compromise of MVA before RMVA starts, which is not possible if RMVA exits normally after restoring the MVA. Then, the system will immediately call RMVA again, and give exclusive control to it. RMVA then performs the validation of level 1 components again. If validation of MVA fails again, this procedure may be repeated a certain number of times as determined by a counter and a policy of RMVP. If restoring of MVA as above fails, RMVA may instead load a fallback code image from another trusted location, and load it to the storage location of the MVA or to another, dedicated, storage location. RMVA may then set a protected flag ‘fallback’ and reset the system state as above. When RMVA is called again in this case, it will validate the fallback code against a TRV, which also part of RMVP. If that validation succeeds, RMVA directly hands over execution to the fallback code. If it fails, RMVA may repeat the fallback procedure a certain number of times as described before in the case of MVA restoration. If validation of the fallback code still fails, RMVA may send out a distress signal and halt the system. When the fallback code is executed, it may perform certain actions to diagnose and repair the system and may also provide a remotely accessible interface for this purpose.

BOOT is compromised. In this case, the further startup and validation of level 2 cannot proceed, since the according startup functionality (BOOT) is not available, respectively, the according TRVs cannot be validated. However it is assumed that MVA is successfully validated in this case, and can therefore be used to perform extended remediation procedures. For this, differently from normal startup described above, RMVA may set a protected flag ‘remediate boot’, and hand over execution control to MVA. MVA may then contact that source and request a BOOT remediation package. When it receives that package from the source, MVA then validates it using an appropriate credential of VMRCS. Upon success, MVA replaces the code and data of BOOT with the received package. Then, MVA hands back execution control to RMVA which re-validates the level 1 components as described in the other cases above.

In some cases, the VMRCS may be compromised. In this case, in accordance with an example, the MVA is provided with a trustworthy source for new root credentials. For this, the RMVA may replace the credentials in VMRCS with a single credential, a ‘root remediation credential’ which authenticates (a) trustworthy source(s) for validation and management root credentials, which may be contained, for instance, in RMVP. Then, RMVA may set a protected flag ‘remediate root trust’, and hand over execution control to MVA. MVA may then contact that source and request a VMRCS remediation package. When it receives that package from the source, MVA then validates it using the root remediation credential. Upon success, MVA replaces the contents of VMRCS with the received package. Then, MVA hands back execution control to RMVA which re-validates the level 1 components as described in the other cases above.

In some cases, the MVA is responsible for the validation of level 2 components and associated data and according remediation procedures. For this, MVA may validate the contents of TRVS using credentials in VMRCS. To validate level 2 components, MVA uses the measurements performed by RMVA on HV and GOS components, which are stored in PCR HV and PCR_GOS. The purpose of this method is to endow the measurements of the most critical components of the platform, i.e., HV and critical parts of GOS, with additional security, by measuring them at an early level when RMVA has exclusive control over the system resources. A drawback of this method may be that the measurements taken by RMVA are statically configured in RMVP.

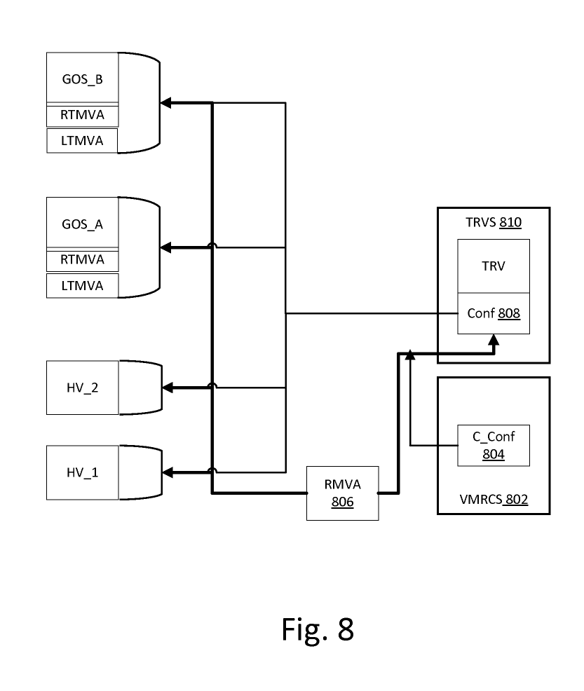

Referring now to FIG. 8, as described above the measurement targets of level 2 components HV and GOS may be configurable in the startup of level 0. For this, a VMRCS 802 may contain a particular credential C_Conf 804. After the validation of VMRCS 802, this credential may be used, for instance by way of verifying a digital signature, by an RMVA 806, to validate a special storage area containing configuration data Conf 808 in trusted reference value storage (TRVS) 810. The data Conf 808 identifies the measurement targets of RMVA 806, e.g., specifics that MRVA needs to execute the measurement of level 2 components. The specifics may include, for example and without limitation, measurement algorithms, storage device identifiers, starting addresses in non-volatile storage, and length of data segments in such memory which are to be measured. For a change of the measurement targets, it is then for instance possible to replace the data Conf 808 with an updated, digitally signed image. FIG. 8 shows an situation where a multitude of hypervisors (e.g., HV_1 and HV_2) and GOS images (e.g., GOS_A and GOS_B) are present and identified by Conf 808 in non-volatile storage. As also shown, measurement target storage areas may differ for different GOS images.

For validation of level 2 components, the MVA may first validate the contents of TRVS 810 using credentials in the VMRCS 802. If any TRV fails this validation, the MVA (e.g., RMVA 806) may try to obtain a correct TRV from a trusted source. Such a trusted source may be identified by the corresponding credential of VMRCS 802, which was used to validate the former TRV for example. In some cases, if such remediation of the corrupted TRV fails, the corresponding level 2 component is also considered corrupted and may not be started.

To validate HV and GOS, MVA compares the values of the PCRs, PCR_HV and PCR_GOS with the corresponding TRVs, TRV_HV and TRV_GOS, respectively. Different remediation policies may be applied by MVA when any of the aforementioned validations fails. Those policies may be prescribed by an external entity, for instance the trusted source of the according TRVs. Alternatively, remediation policies may be part of the platform configuration Conf 808. Examples of remediation policies are now discussed.

In one example policy, if HV fails validation, the MVA may try to obtain a correct HV image from a trusted source as above. If that fails, MVA may try to load a restricted HV image from non-writeable storage and hand execution control to that image for further remediation. As a last option, MVA may send a signal to an outside party, such as the platform owner, which may be identified by the platform configuration Conf. MVA may provide a remotely accessible interface to that party for further remote diagnostics and remediation.

In another example policy, if a GOS fails validation, MVA may enter in a process of fine granular validation. MVA may then validate various sub-components of the OS, in particular LTMVA and RTMVA, using according TRVs from TRVS 810 for example, to localize the failure point. If the main security critical parts of GOS validate OK, the GOS may still be started with all components failing validation disabled. Higher level security functions of the GOS, such as malware scanners, may then be activated to diagnose the cause of the component compromise and perform remediation with or without the help of remote parties.

In yet another example policy, if LTRVs fail to validate, the corresponding VAPPs must not be loaded, because they cannot be validated, since their reference values are compromised. MVA may first try to obtain corrected LTRVs from a trusted source identified and authenticated by an appropriate credential from VMRCS. If that remediation of LTRVs fails, MVA may prepare a list of VAPPs which must not be loaded. This list is processed by LTMVA, which prevents the according VAPPs from loading and starting.

Level 3 components are the applications running on a guest OS, and level 3 components may be subject to load-time and run-time validation. Validation of these VAPPs is performed by LTMVA and RTMVA, respectively. Those entities are also responsible for according remediation procedures. First, in accordance with one example, the LTMVA may validate every VAPP for which a corresponding LTRV is available. The responses and remediation steps that may be applied by LTMVA for each failed VAPP include, among others, one in which the LTMVA prevents the failed component from being started by itself or any other entity. For that, LTMVA may additionally move the code and data image of the failed VAPP to a storage container, which may for instance be an encrypted storage.

In analogy to the method described above for level 2, LTRVs may be augmented by additional configuration data which may also contain additional policies which prescribe remediation steps for specific VAPPs. Those steps may comprise blocking access to certain system resources by the VAPP, or specify an alarm message to be sent out to an outside entity.

LTMVA may enter a procedure for platform validation and management using an outside service, in order to obtain corrected code and data images for the failed VAPPs.

Run-time validation of loaded VAPPs is performed by LTMVA, using RTRVs which have been created by LTMVA at the time of loading VAPPs. Remediation procedures performed by RTMVA depend specifically on the situation at which a compromise of a VAPP is detected by RTMVA (see below on technical specifics of run-time validation).

If compromise of a segment of a VAPP is detected at the instance of loading a memory segment from temporary storage (e.g., a ‘swapped out’ memory page), RTMVA may try to recover that segment from the stored image of VAPP and prevent further offloading of the VAPP to temporary memory (swapping).

RTMVA may stop the execution of a VAPP and/or unload it from working memory. Depending on configured policies, RTMVA may then return control to LTMVA to try and load an uncompromised code image of the VAPP again, for a certain, specified number of times.

With respect to management, as used herein, management refers to the controlled replacement, for instance for the purpose of updating a component, of a system component. Particularly, remote platform management may involve an outside entity that is connected via a network link to the platform to perform such updates. Various methods for platform management which make essential use of the platform capabilities for validation, have been described previously as methods for Platform Validation and Management (PVM) and are not reiterated at this time. Those PVM methods can be directly applied to, and integrated with the presently described system.

It is recognized herein that variations in the architecture and functionality of the present system may improve the capabilities to perform PVM. In one example embodiment, management of VMRCS is possible when the information of RMVP used to validate its contents is a public key certificate, and not a fixed value TRV. In this case, validation of the contents of VMRCS may consist in verifying, by RMVA a signature, also contained in VMRCS, and using the latter public key, over the remainder of the contents of VMRCS. Then, additionally, RMVA validates the public mentioned public key against the mentioned certificate from RMVP. For managed update of VMRCS, the analogous method as above for remediation may be used.

In another example variant, it is possible to make MVA and BOOT manageable by MVA itself For this, MVA and/or BOOT may be removed from the validation based on data contained in the RMVP. For example, the RMVA may validate VMRCS using TRV_VMRC from RMVP. The RMVA may validate TRV_B and TRV_MVA against appropriate credentials in VMRCS. The RMVA may validate BOOT and MVA against TRV_B and TRV_MVA, respectively. In this trust configuration, MVA can obtain new TRVs (TRV_B and TRV_MVA) from a trusted authority, obtain associated code and data updates from the same or another trusted authority, update the MVA and BOOT code and data in non-volatile storage, and restart the system by handing back execution control to RMVA. The RMVA may also validate TRVS, for instance all TRVs, in this configuration, thereby relieving MVA from this duty.

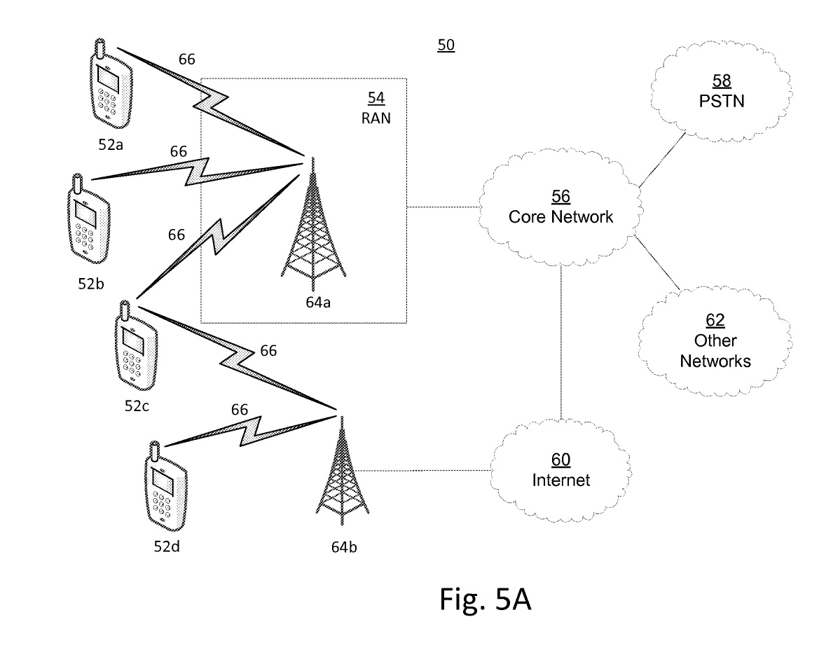

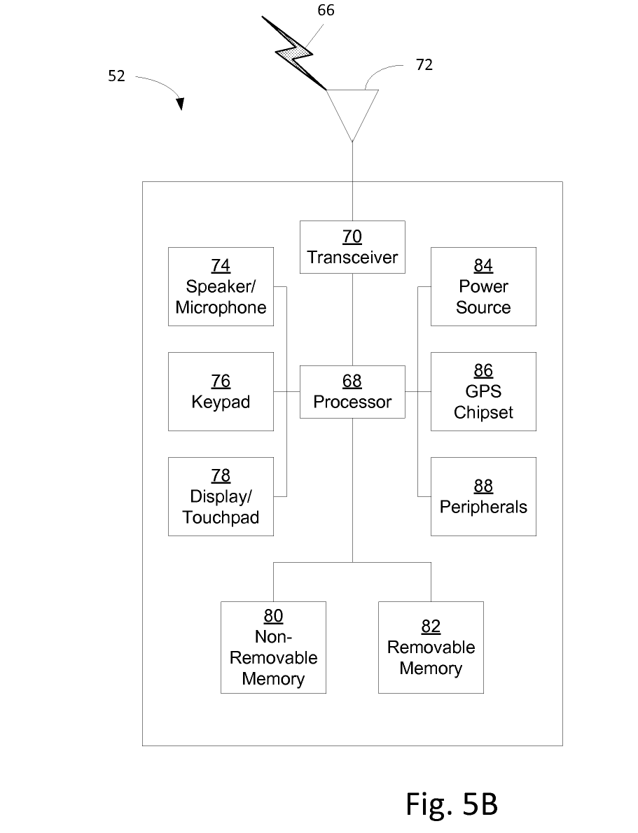

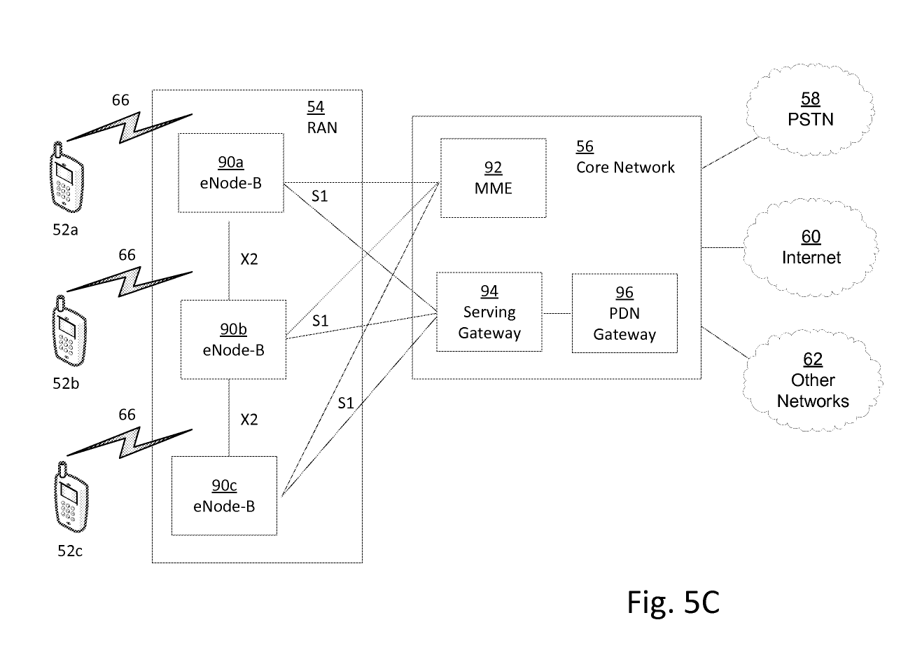

FIG. 5A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 5A, the communications system 50 may include wireless transmit/receive units (WTRUs) 52a, 52b, 52c, 52d, a radio access network (RAN) 54, a core network 56, a public switched telephone network (PSTN) 58, the Internet 60, and other networks 62, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64b may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64b may be a base transceiver station (BTS), a Node-B, an eNode B, a Home Node B, a Home eNode B, a site controller, an access point (AP), a wireless router, and the like. While the base stations 64a, 64b are each depicted as a single element, it will be appreciated that the base stations 64a, 64b may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64b may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64b may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 66 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64b in FIG. 5A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64b and the WTRUs 52c, 52d may implement a radio technology such as IEEE 802.11 to establish a wireless local area network (WLAN). In an embodiment, the base station 64b and the WTRUs 52c, 52d may implement a radio technology such as IEEE 802.15 to establish a wireless personal area network (WPAN). In yet an embodiment, the base station 64b and the WTRUs 52c, 52d may utilize a cellular-based RAT (e.g., WCDMA, CDMA2000, GSM, LTE, LTE-A, etc.) to establish a picocell or femtocell. As shown in FIG. 5A, the base station 64b may have a direct connection to the Internet 60. Thus, the base station 64b may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 5A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 5A may be configured to communicate with the base station 64a, which may employ a cellular-based radio technology, and with the base station 64b, which may employ an IEEE 802 radio technology.

FIG. 5B is a system diagram of an example computing system, for instance a WTRU 52. As shown in FIG. 5B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 68 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 5B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet an embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 5B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 68 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 68 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 5C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 5C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 5C, the Node-Bs 90a, 90b may be in communication with the RNC 92a. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macro-diversity, security functions, data encryption, and the like.

The core network 56 shown in FIG. 5C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

The following acronyms are defined below, unless otherwise specified herein:
App Application program
BOOT Bootloader
BP Boot Policies
GOS Guest Operating System
HMVA Hypervisor MVA
HTRV Hypervisor TRV
HP Hypervisor Policies
HV Hypervisor
I/O Input/Output System
LOAD Program Loader
LTP Load-Time Policies
MEM Memory Manager
Mod/Lib System modules and system/installed shared libraries
MVA Management and Validation Agent with sub-species Load-Time (LTMVSA), and Run-Time—(RTMVA) MVA.
NVS Non-Volatile Storage
OSK Operating System Kernel
RC Root Credentials
RoT Root of Trust
RP Root Policies
RTM Run-Time Memory
RTP Run-Time Policies
SecP Security Processor
TAM Trusted Access Monitor
TCB Trusted Computing Base
TrE Trusted Environment
TRV Trusted Reference Values with sub-species Boot—(BTRV), Load-Time—(LTRV), Run-Time—(RTRV) TRV.
VM Virtual Machine

1. A method comprising:
performing a secure boot of a base computing platform (BCP), verifying an integrity of and instantiating a security processor on the BCP;
verifying an integrity of one or more subsequent startup components of the BCP, using the security processor, the one or more subsequent startup components comprising at least one of boot code, an operating system, or a hypervisor;
creating a plurality of virtual machines on the BCP;
providing the plurality of virtual machines with virtual access to the security processor on the BCP;
performing a secure start-up of a first virtual machine of the plurality of virtual machines, wherein a guest owner takes ownership of the first virtual machine; and
verifying an integrity of and instantiating a virtual security processor in the first virtual machine.

2. The method as recited in claim 1, the method further comprising:
creating and storing at least one trusted reference value at an initial load of a component, thereby creating a run-time trusted reference value;
validating the component at load-time to create a load-time validation; and
securely binding the load-time validation to the run-time trusted reference value.

3. The method as recited in claim 2, the method further comprising:
maintaining, by the BCP, an integrity of the BCP during run-time operation; and
maintaining a log when unloading a subcomponent of the component.

4. The method as recited in claim 3, the method further comprising:
determining that a previously unloaded subcomponent is being reloaded; and
performing an integrity check of the subcomponent before reloading the subcomponent.

5. The method as recited in claim 3, wherein the component comprises at least one of code or data, and the subcomponent comprises a portion of the code or data.

6. The method as recited in claim, the method further comprising:
providing a remote attestation authority with attestation information at startup and during run-time, thereby providing an indication of trust associated with the BCP.

7. (canceled)

8. The method as recited in claim 1, the method further comprising:
verifying an integrity of one or more subsequent startup components in the first virtual machine using the virtual security processor, wherein the subsequent startup components in the virtual machine comprise at least one of an operating system (OS) or applications running thereon.

9. The method as recited in claim 8, the method further comprising:
creating and storing a trusted reference value at an initial load of a component, thereby creating a run-time trusted reference value;
validating the component at load-time to create a load-time validation; and
securely binding the load-time validation to the run-time trusted reference value.

10. The method as recited in claim 9, the method further comprising:
maintaining, by the first virtual machine, an integrity of the BCP during run-time operation; and
maintaining a log when unloading a subcomponent of the component.

11. The method as recited in claim 10, the method further comprising:
determining that a previously unloaded subcomponent is being reloaded; and
performing an integrity check of the subcomponent before reloading the subcomponent.

12. The method as recited in claim 10, wherein the component comprises code or data, and the subcomponent comprises a portion of the code or data.

13. The method as recited in claim 1, wherein the security processor comprises a trust access monitor that executes policies to enforce access to resources comprising at least one of a memory, peripheral, communication port, or displays.

14. A computing system comprising a processor and memory, the computing system further comprising computer-executable instructions stored in the memory which, when executed by the processor of the computing system, perform operations comprising:
performing a secure boot of a base computing platform (BCP);
verifying an integrity of one or more subsequent startup components of the BCP, using the security processor, the one or more subsequent startup components comprising at least one of boot code, an operating system, or a hypervisor;
creating a plurality of virtual machines on the BCP;
providing the plurality of virtual machines with virtual access to the security processor on the BCP;
performing a secure start-up of a first virtual machine of the plurality of virtual machines, wherein a guest owner takes ownership of the first virtual machine; and
verifying an integrity of and instantiating a virtual security processor in the first virtual machine.

15. The computing system as recited in claim 14, further comprising computer-executable instructions, which when executed by the processor of the computing system, perform further operations comprising:
creating and storing a trusted reference value at an initial load of a component, thereby creating a run-time trusted reference value;
validating the component at load-time to create a load-time validation; and
securely binding the load-time validation to the run-time trusted reference value.

16. The computing system as recited in claim 15, further comprising computer-executable instructions, which when executed by the processor of the computing system, perform further operations comprising:
maintaining, by the BCP, an integrity of the BCP during run-time operation;
unloading a subcomponent of the component; and
performing an integrity check of the subcomponent before reloading the subcomponent.

17. The computing system as recited in claim 16, further comprising computer-executable instructions, which when executed by the processor of the computing system, perform further operations comprising:

18. The computing system as recited in claim 14, further comprising computer-executable instructions, which when executed by the processor of the computing system, perform further operations comprising:
providing a remote attestation authority with attestation information at startup and during run-time, thereby providing an indication of trust associated with the BCP.

19. (canceled)

20. The computing system as recited in claim 14, further comprising computer-executable instructions, which when executed by the processor of the computing system, perform further operations comprising:
verifying an integrity of one or more subsequent startup components in the first virtual machine using the virtual security processor, wherein the subsequent startup components in the virtual machine comprise at least one of an operating system (OS) or applications running thereon.

21. The computing system as recited in claim 14, further comprising computer-executable instructions, which when executed by the processor of the computing system, perform further operations comprising:
creating and storing a trusted reference value at an initial load of a component, thereby creating a run-time trusted reference value;
validating the component at load-time to create a load-time validation; and
securely binding the load-time validation to the run-time trusted reference value.

22. The computing system as recited in claim 21, further comprising computer-executable instructions, which when executed by the processor the computing system, perform further operations comprising:
maintaining, by the first virtual machine, an integrity of the BCP during run-time operation; and
unloading a subcomponent of the component;

23. The method as recited in claim 22, further comprising computer-executable instructions, which when executed by the processor of the computing system, perform further operations comprising:
performing an integrity check of the subcomponent before reloading the subcomponent.

24. The computing system as recited in claim 23, wherein the component comprises code and data, and the subcomponent comprises a portion of the code or data.
